(19) United States
(12) Patent Application Publication
(10) Pub. No.: US 2008/0229045 A1
(43) Pub. Date: Sep. 18, 2008

(54) STORAGE SYSTEM PROVISIONING ARCHITECTURE

(75) Inventor: Yanling Qi, Austin, TX (US)

Correspondence Address: LSI CORPORATION, 1621 BARBER LANE, MS: D-106, MILPITAS, CA, 95035, US

(73) Assignee: LSI LOGIC CORPORATION, Milpitas, CA (US)

(21) Appl. No.: 11/687,124

(22) Filed: Mar. 16, 2007

(51) Int. Cl. G06F 12/06

(52) U.S. Cl. 711/170; 711/E12.084

(57) ABSTRACT

In some embodiments, a storage controller comprises a first input/output port that provides an interface to a host computer, a second input/output port that provides an interface a storage device, a processor that receives input/output requests generated by the host computer and, in response to the input/output requests, generates and transmits input/output requests to the storage device, and a memory module communicatively connected to the processor. The memory module comprises logic instructions stored in a computer-readable medium which, when executed by the processor, configure the processor to receive, from the host computer, a write input/output request that identifies a logical volume; compare an amount of storage space available in the logical volume with an amount of storage space required to complete the write operation, and allocate additional storage space to the logical volume if the amount of storage space available in the logical volume is insufficient to complete the write operation. Other embodiments may be described.

### BACKGROUND

The subject matter described herein relates generally to the field of electronic computing and more particularly to storage system provisioning architecture.

Traditional, fully provisioned techniques tend to waste storage space, as users and/or administrators over-provision storage to avoid manual intervention and complexity of future allocations of growth. Storage analysts estimated that up to 75% of allocated space is not physically used. More efficient techniques for provisioning storage space may find utility.

### BRIEF DESCRIPTION OF THE DRAWINGS

FIG. 1 is a schematic illustration of physical components of a storage system in accordance with some embodiments.

FIG. 2 is a schematic illustration of a logical view of a storage system in accordance with some embodiments.

FIG. 3 is a flowchart illustrating a method for communicating a capacity of a storage system in accordance with some embodiments.

FIG. 4 is a flowchart illustrating a method for implicit storage space allocation in accordance with some embodiments.

FIG. 5 is a flowchart illustrating a method for explicit storage space allocation in accordance with some embodiments.

FIGS. 6-8 illustrate aspects of a pre-allocate command in accordance with some embodiments.

FIG. 9 is a flowchart illustrating a method for explicit storage space de-allocation in accordance with some embodiments.

FIGS. 10-12 illustrate aspects of a pre-allocate command in accordance with some embodiments.

### DETAILED DESCRIPTION

Described herein are exemplary systems and methods for storage system provisioning which may be used in, e.g., storage systems. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

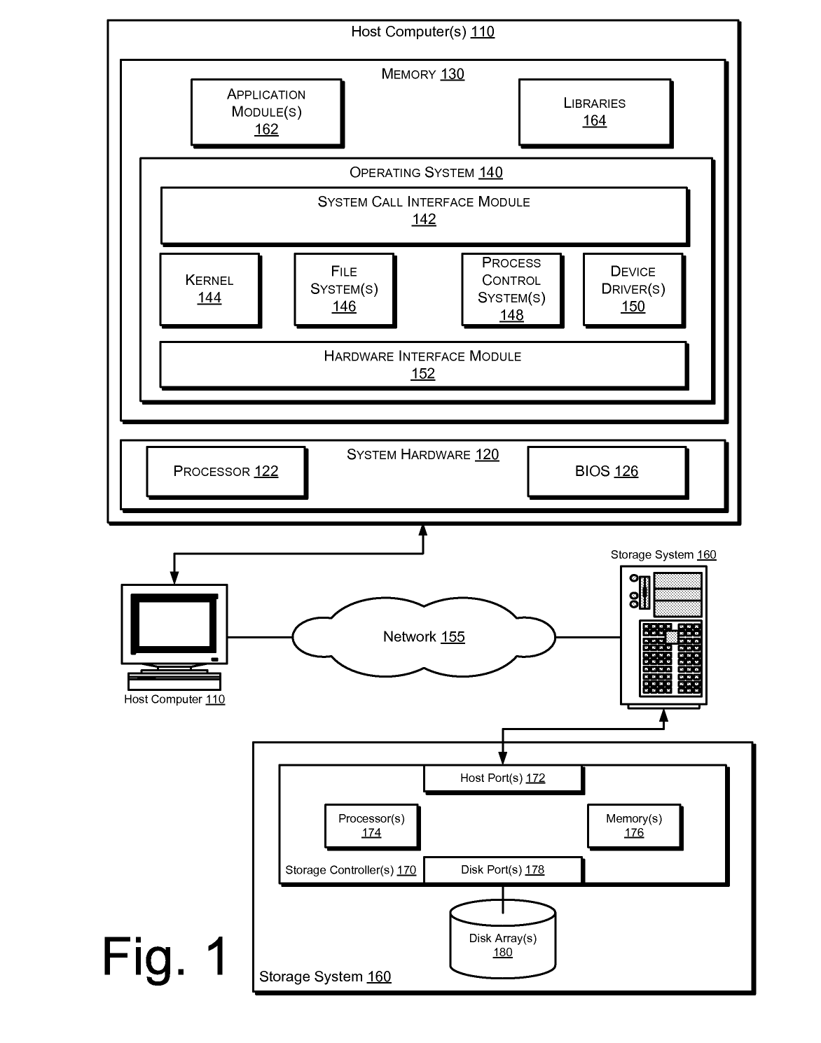

FIG. 1 is a schematic illustration of physical components of a storage system in accordance with some embodiments. Referring to FIG. 1, a storage system 100 may include one or more host computers 110 coupled to one or more storage systems 160 via a communication network 155.

Host computer(s) 110 include system hardware 120 commonly implemented on a motherboard and at least one auxiliary circuit boards. System hardware 120 includes, among other things, a processor 122 and a basic input/output system (BIOS) 126. BIOS 126 may be implemented in flash memory and may comprise logic operations to boot the computer device and a power-on self-test (POST) module for performing system initialization and tests. In operation, when activation of computing system 100 begins processor 122 accesses BIOS 126 and shadows the instructions of BIOS 126, such as power-on self-test module, into operating memory. Processor 122 then executes power-on self-test operations to implement POST processing.

Computer system 110 further includes memory 130, which may be implemented as random access memory (RAM), dynamic random access memory (DRAM), read-only memory (ROM), magnetic memory, optical memory, or combinations thereof. Memory 130 includes an operating system 140 for managing operations of computer 110. In one embodiment, operating system 140 includes a hardware interface module 154 that provides an interface to system hardware 120. In addition, operating system 140 includes a kernel 144, one or more file systems 146 that manage files used in the operation of computer 110 and a process control subsystem 148 that manages processes executing on computer 110.

Operating system 140 further includes one or more device drivers 150 and a system call interface module 142 that provides an interface between the operating system 140 and one or more application modules 162 and/or libraries 164. The various device drivers 150 interface with and generally control the hardware installed in the computing system 100.

In operation, one or more application modules 162 and/or libraries 164 executing on computer 108 make calls to the system call interface module 142 to execute one or more commands on the computer's processor. The system call interface module 142 invokes the services of the file systems 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 can be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.) or as a Windows® brand operating system. Computer system 110 may include one or more accompanying input/output devices such as, e.g., a display, a keyboard, and a mouse, and the like.

Storage system 160 generally comprises one or more storage controllers 170 coupled to one or more disk arrays 180, or other storage media. Storage controller 170 manages input/output (I/O) requests from host computer(s) 110 for storing and retrieving information on one or more disk arrays 180. Storage controller 170 may one or more host ports 172 that couple to network 155 to provide a communication interface with host computer(s) 110. Host ports 172 may include appropriate logic for interfacing with attached host computer(s) 110 via appropriate protocols and media associated with communication network 155. For example, communication network 155 may utilize PCI, PCI-X, other parallel bus structures, and high speed serial interface communication paths or the like.

Storage system controller 170 may also include one or more disk port(s) 178 which provide an interface for interacting with attached disk arrays 180. Disk ports 178 may operate according to Fibre Channel, parallel SCSI, other parallel bus structures, and other high speed serial communication media and protocols. Disk ports 178 therefore represent any of several well-known, commercially available interface elements for exchanging information with attached disk arrays 180.

Storage controller 170 may include one or more processors 174 to control overall operation of storage controller 170. Processor may fetch and execute programmed instructions as well as associated variables from program memory 176. Memory 110 may be any suitable memory device for storing programmed instructions and/or associated data to be executed or manipulated by processor 174 including, for example, ROM, PROM, EPROM, flash memory, RAM, DRAM, SDRAM, etc.

Memory 176 may include cache memory, which may be utilized as a buffer for storing data supplied by a host computer 110 in an I/O write request. Data to be read from, and written to, disk arrays 180 may be staged in cache memory. A direct memory access (DMA) controller may effectuate transfers between elements of the controller 170.

Those of ordinary skill in the art will recognize a wide variety of equivalent structures to that of storage system 1 of FIG. 1 to provide features and aspects hereof. In particular, numerous additional functional elements may be recognized by those of ordinary skill in the art as desirable for implementing a fully featured storage system controller 170. Still further, additional integration of components will be readily apparent where, for example, DMA controller and processor may be integrated within a single microcontroller component. In addition, those of ordinary skill in the art will recognize that processor 174 may be any of a variety of general purpose or special purpose processors adapted for overall control of storage controller 170.

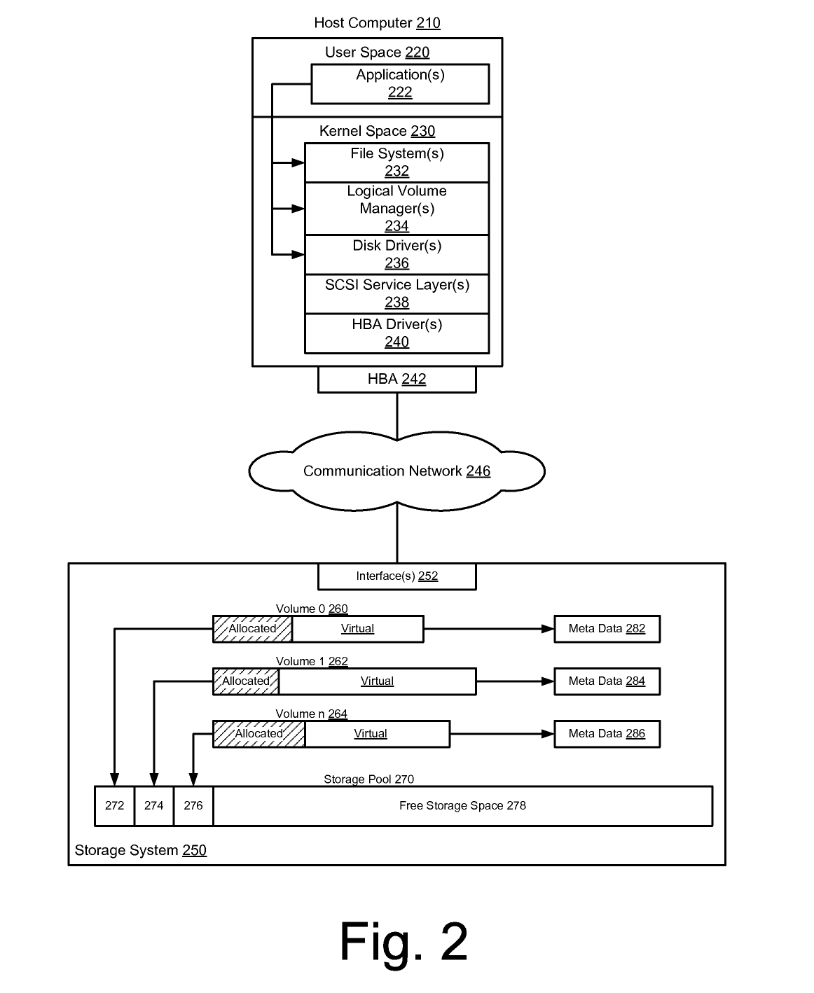

FIG. 2 is a schematic illustration of a logical view of a storage system in accordance with some embodiments. The host computer 210 depicted in FIG. 2 may correspond to the host computer 110 depicted in FIG. 1. Similarly, the storage system 250 depicted in FIG. 2 may correspond to storage system 160 depicted in FIG. 1.

Referring to FIG. 2, one or more applications 222 execute in the user space 220 of the operating system of host computer system 210. The kernel space 230 of host computer 210 comprises one or more file system(s) 232, logical volume manager(s) 234, disk driver(s) 236, SCSI services layer(s) 238, and host bus adapter driver(s) 240. A host bus adapter 242 couples the host computer 210 to communication network 246.

Storage system 250 is coupled to communication network via interface 246. The storage space implemented by disk arrays 180 is aggregated into a storage pool 270 of storage space. For example, a set of disk drives from the disk arrays 180 may form a shared storage pool for a number (n) of logical volumes, depicted in FIG. 2 as volume 0 260, volume 1, 262, up to volume n 264. A subset of drives in the disk arrays 180 can form a RAID group with a specified RAID level. The set of volumes allocate storage space from the shared storage pool 270.

Each logical volume may be associated with a meta data object that contains volume configuration information and LBA (logical block address) mapping information between logical volume LBAs and physical disk drive or RAID LBAs. For example, in FIG. 2, logical volume 0 is associated with meta data object 282, volume 1 162 is associated with meta data object 284, and volume n is associated with meta data object 286.

In use, applications executing on host computer 210, or on one or more client computers coupled to host computer 210, consume storage resources provided by storage system 250. For example, application I/O requests may be passed from an application 222 executing in the user space 220 of the operating system to the kernel I/O driver stack, and finally through the HBA (Host Bus Adapter) 242 and SAN to the storage system 250.

In some embodiments, storage system 250 implements deferred storage space allocation for logical volumes 260, 262, 264. For example, when a new logical volume is configured in a storage system 250, the volume may be configured with a “nominal” capacity. The nominal capacity may be determined by an information technology (IT) administrator based on factors such as, e.g., an organization's business activity and an application's expected growth in the consumption of storage resources.

When the logical volume is configured, storage system 250 allocates only a small amount of physical storage space for the logical volume based on application storage layout patterns. Storage system 250 may defer allocating physical storage space until either a “write” I/O request time (i.e., allocation on write or AOW, also referred to as “implict” allocation) or the time of an explicit storage space allocation I/O request from a SCSI initiator, e.g., a host application(s).

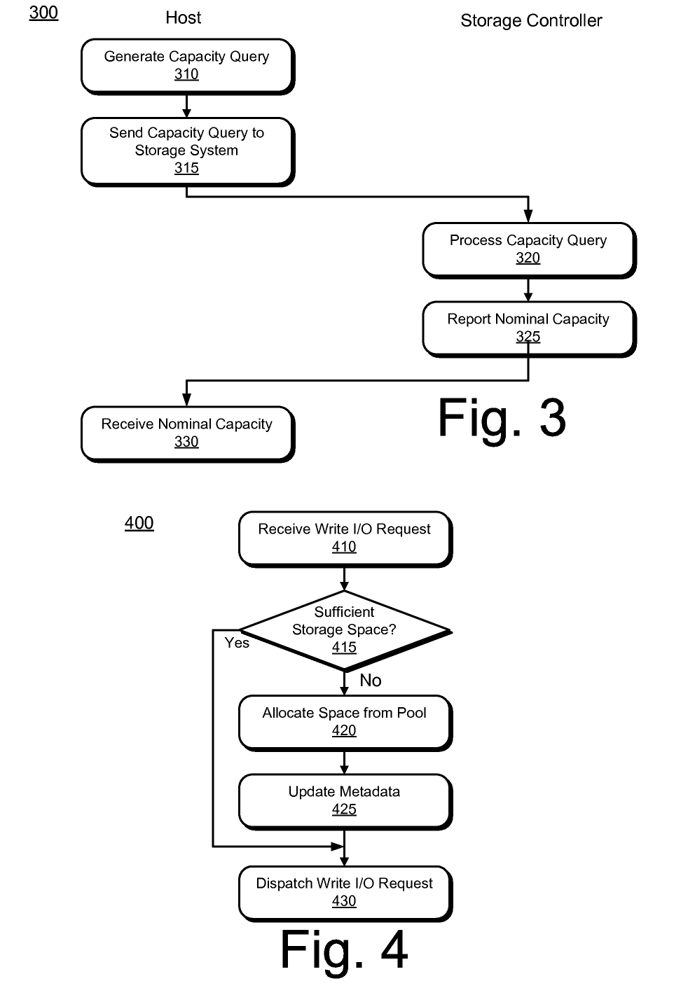

In operation, a host computer system may query a logical volume's storage capacity through SCSI command “READ CAPACITY” command. FIG. 3 is a flowchart illustrating a method for communicating a capacity of a storage system in accordance with some embodiments. Referring to FIG. 3, at operation 310 the host computer 210 generates a capacity query. At operation 315 the host computer system 210 transmits the capacity query to the storage system 250.

At operation 320 the storage controller 250 processes the READ CAPACITY request, and at operation 325 the storage controller 250 reports the available capacity to the host computer 250. In some embodiments, the storage system 250 may return the READ CAPACITY parameter data with nominal capacity to the host computer 210.

As described above, when a logical volume is configured, storage space is not immediately dedicated to the logical volume. In some embodiments, in response to a write operation of file system meta data to disk storage, storage controller 170 will initiate an implicit storage space allocation in a logical volume. FIG. 4 is a flowchart illustrating a method for managing a write input/output request in accordance with some embodiments. Referring to FIG. 4, at operation 410 a write I/O request is received in a storage controller 170. In some embodiments, a write I/O request may include write data and an identifier that identifies the logical volume (e.g., 260, 262, 264) to which the write I/O operation is directed. In response to the write I/O, the storage controller checks the logical volume's meta data to see if sufficient storage space, (e.g., the requested virtual LBA plus transfer-length) for the requested write I/O has been allocated. If, at operation 415, adequate storage space has been allocated, then control passes to operation 430 and the storage controller 170 may dispatch the write I/O request to an I/O queue.

By contrast, if at operation 415 sufficient storage space (e.g., the requested virtual LBA plus transfer length) was not allocated, then control passes to operation 420 and the storage controller 170 allocates free storage space 278 from the storage pool 270 to the logical volume identified in the write I/O request. In some embodiments, the storage controller 170 allocates adequate space to execute the write I/O request. In alternate embodiments, the storage controller 170 may allocate additional storage space based on one or more prediction algorithm(s). In addition, the storage controller updates the meta data associated with the logical volume addressed in the write I/O operation (operation 425). After the space allocation, the device server will dispatch the I/O request for execution (operation 430).

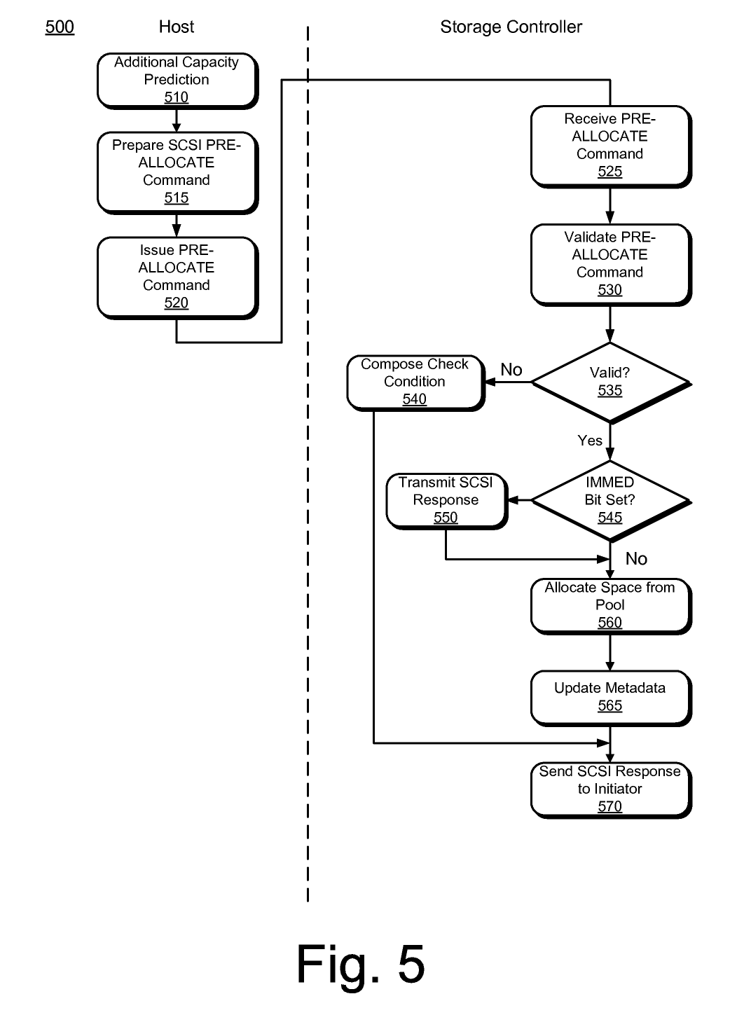

In contrast to the implicit allocation method depicted in FIG. 4, storage space may be explicitly allocated to a logical volume. FIG. 5 is a flowchart illustrating a method for explicit storage space allocation in accordance with some embodiments. Referring to FIG. 5, at operation 510 a host computer predicts that additional capacity will be required. For example, referring briefly to FIG. 2, an application 222 executing on a host computer 210 may determine that additional storage capacity will be needed for one or more logical volumes 260, 262, 264 utilized by the application.

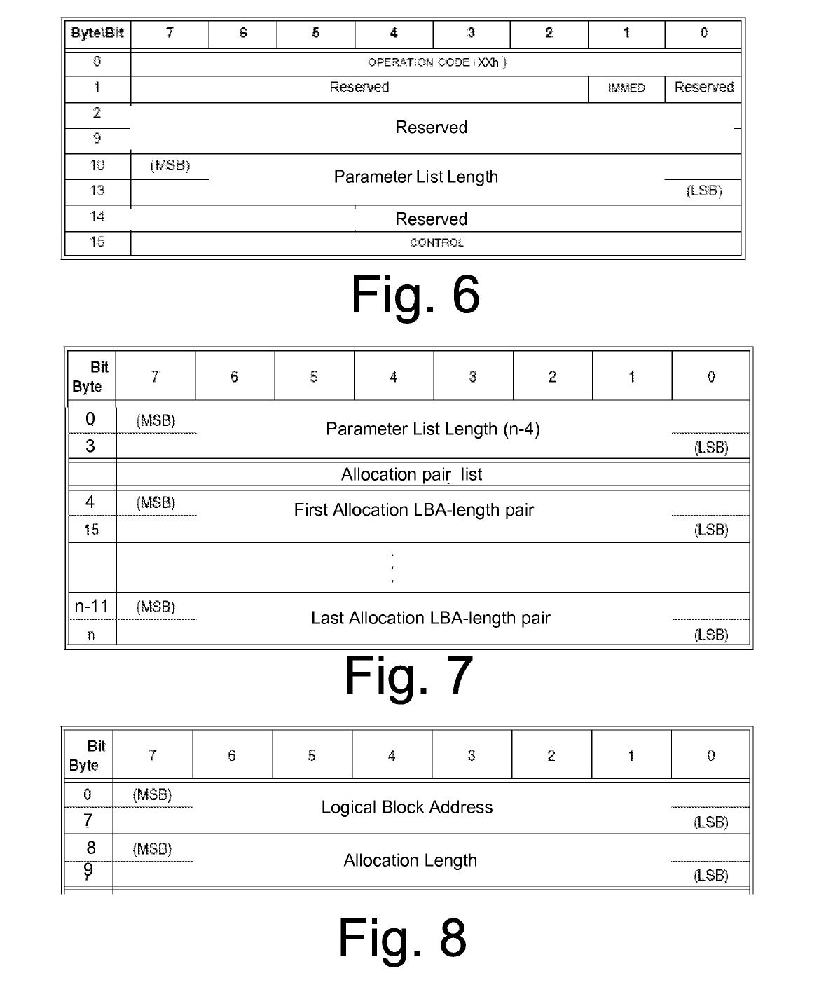

At operation 515 the host computer 210 prepares a request for additional storage space for the logical volume(s) 260, 262, 264 identified in operation 510. In some embodiments, the storage space request may be embodied as a SCSI pre-allocate command. FIGS. 6-8 illustrate aspects of a pre-allocate command in accordance with some embodiments. Referring briefly to FIGS. 6-8, the SCSI command format depicted in FIG. 6 represents one embodiment of a SCSI pre-allocate command. The SCSI command for pre-allocating storage space could be specified in other format as long as a SCSI initiator could order a device server of a SCSI target to allocate specified storage space from a specified logical block address.

Referring to FIG. 6, in one embodiment a pre-allocate command may be transferred in one or more frame structures. The pre-allocate command is assigned a specified operation code (e.g., “XX”). Space is reserved in the frame for a parameter list length field which specifies the length of allocation parameter data of the pre-allocate command. Space is also reserved for an immediate (IMMED) bit. An IMMED bit set to zero specifies that the status of an operation should be returned to the host after the operation is complete. An IMMED bit set to one specifies that the status of an operation should be returned as soon as the CDB has been validated.

Referring to FIG. 7, the pre-allocate command may include a parameter list length field which specifies a length pre-allocate parameter data of the pre-allocate command. The pre-allocate command may further include an allocation pair list which specifies a list of LBA and allocation length pairs. Each allocation pair (see FIG. 8) specifies the starting LBA and number of blocks that needs to be allocated.

Referring back to FIG. 5, an application may explicitly issue a “pre-allocation” SCSI command to request more storage space to be allocated from free storage space 278. For example, an application may periodically check its storage consumption and proactively request more storage space. Alternatively, an application may request additional storage at runtime. The request may be issued by any layer of a host I/O driver stack, by application itself or by user space storage management applications such as the logical volume manager 234 or a resource manager. At operation 520 the host computer issues the pre-allocate command, which is transmitted to the storage controller 170 via the communication network 155.

At operation 525 the storage controller 170 receives the pre-allocate command, and at operation 530 the storage controller 170 validates the pre-allocate command. In some embodiments, validating the pre-allocate command may include validating an identifier associated with the host computer that generated the command, and validating the identifier associated with the logical unit identified in the command. In addition, validating the pre-allocate command may include determining whether there is sufficient storage space in storage pool 278 to satisfy the pre-allocate command.

If, at operation 535, the pre-allocate command is not valid, then a check condition is composed at operation 540. The check condition may be encoded in a SCSI response and returned to the initiator (i.e., the host computer) at operation 570. By contrast, if at operation 535 the pre-allocate command is valid, then control passes to operation 540 and the IMMED bit is examined to determine whether the IMMED bit is set.

If the IMMED bit is set, then a SCSI response is transmitted to the host after the command is validated (operation 550). By contrast, if the IMMED bit is not set, then free storage space 278 from the storage pool 270 is allocated to the logical volume identified in the pre-allocate command. In some embodiments the pre-allocate command allocates an amount of space corresponding to the allocation length parameter identified in the command (FIG. 8), beginning at the logical block address specified in the command (FIG. 8).

Control then passes to operation 565 and the meta data associated with the logical volume identified in the pre-allocate command is updated to reflect the allocation of storage space to the logical volume. At operation 570 a SCSI response is transmitted to the host computer indicating that the command has been completed.

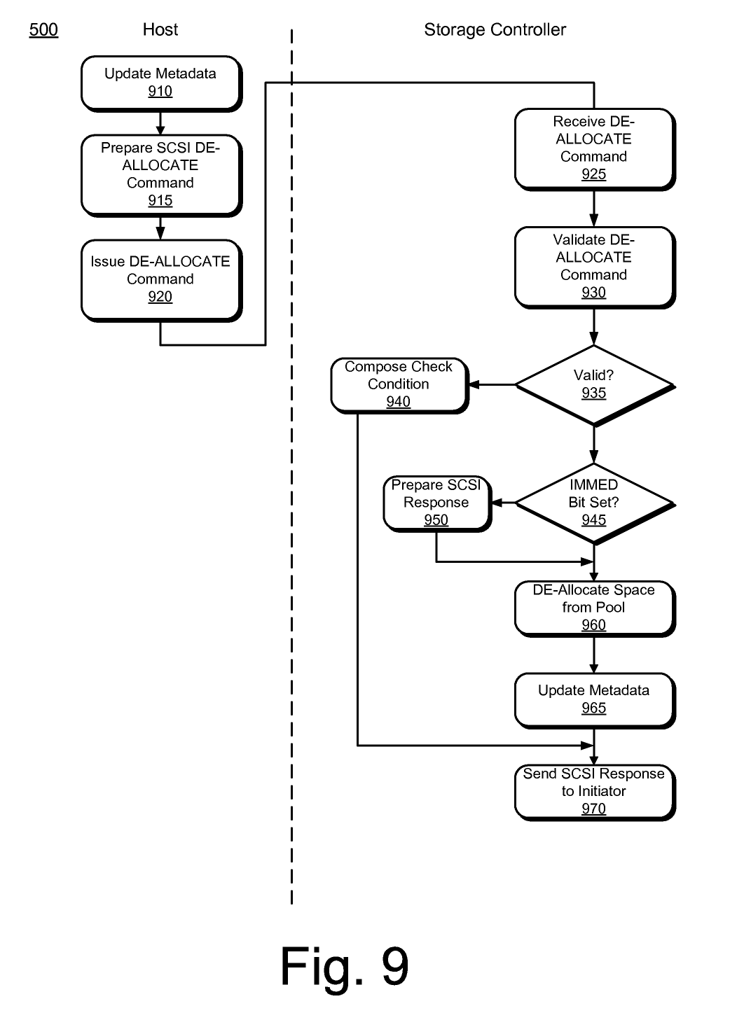

In some embodiments a host computer may also explicitly de-allocate space from a logical volume. FIG. 9 is a flowchart illustrating a method for explicit storage space de-allocation in accordance with some embodiments. The operations of FIG. 9 may be implemented when, for example an application 222 executing on a host computer 210 may determine that a logical volume(s) 260, 262, 264 currently includes more storage space than required.

Referring to FIG. 9, at operation 910 a host computer updates the meta data in the application associated with the storage space allocated to the application. For example, the host computer may update the file system block bitmap and an inode bitmap. In addition, the host computer may identify the logical volume(s) from which storage space is to be de-allocated

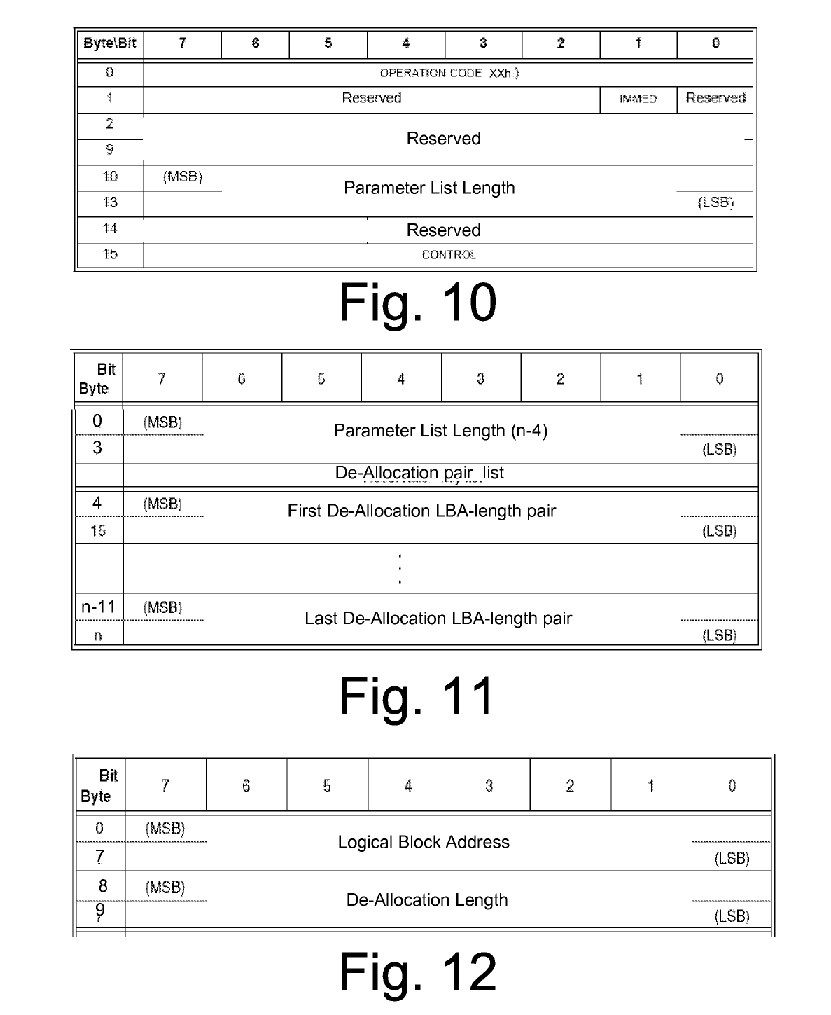

At operation 915 the host computer 210 prepares a request to de-allocate storage space for the logical volume(s) 260, 262, 264 identified in operation 910. In some embodiments, the storage space request may be embodied as a SCSI de-allocate command. FIGS. 10-12 illustrate aspects of a de-allocate command in accordance with some embodiments. Referring briefly to FIGS. 10-12, the SCSI command format depicted in FIG. 10 represents one embodiment of a SCSI de-allocate command. The SCSI command for de-allocating storage space could be specified in other format as long as a SCSI initiator could order a device server of a SCSI target to de-allocate specified storage space from a specified logical block address.

Referring to FIG. 10, in one embodiment a de-allocate command may be transferred in one or more frame structures. The de-allocate command is assigned a specified operation code (e.g., “XX”). Space is reserved in the frame for a parameter list length field which specifies the length of de-allocate parameter data of the de-allocate command. One embodiment of the de-allocate parameter data is specified in FIG. 11. The parameter data specifies a list of LBA and de-allocation length pairs. Each pair (see FIG. 12) specifies the starting LBA and number of blocks that needs to be de-allocated. Space is also reserved for an immediate (IMMED) bit. An IMMED bit set to zero specifies that the status of an operation should be returned to the host after the operation is complete. An IMMED bit set to one specifies that the status of an operation should be returned as soon as the CDB has been validated.

Referring back to FIG. 9, an application may explicitly issue a “de-allocation” SCSI command to de-allocate space from a logical volume 260, 262, 264 to free storage space 278. At operation 920 the host computer issues the de-allocate command, which is transmitted to the storage controller 170 via the communication network 155.

At operation 925 the storage controller 170 receives the de-allocate command, and at operation 930 the storage controller 170 validates the de-allocate command. In some embodiments, validating the pre-allocate command may include validating an identifier associated with the host computer that generated the command, and validating the identifier associated with the logical unit identified in the command.

If, at operation 935, the de-allocate command is not valid, then a check condition is composed at operation 940. The check condition may be encoded in a SCSI response and returned to the initiator (i.e., the host computer) at operation 970. By contrast, if at operation 935 the pre-allocate command is valid, then control passes to operation 940 and the IMMED bit is examined to determine whether the IMMED bit is set.

If the IMMED bit is set, then a SCSI response is transmitted to the host after the command is validated (operation 950). By contrast, if the IMMED bit is not set, storage space consumed by the logical volume identified in the deallocate command is returned to free storage space 278 in the storage pool 270. In some embodiments the de-allocate command de-allocates an amount of space corresponding to the de-allocation LBA-length parameters identified in the command (FIG. 11), beginning at the logical block address specified in the command (FIG. 12).

Control then passes to operation 965 and the meta data associated with the logical volume identified in the de-allocate command is updated to reflect the de-allocation of storage space to the logical volume. At operation 970 a SCSI response is transmitted to the host computer indicating that the command has been completed.

Thus, the systems and methods described herein enable a storage system to conserve storage space by deferring storage space allocation until a host computer requests allocation of the storage space, either explicitly or implicitly. Storage space may be implicitly allocated to a logical volume by an application in response to a write I/O operation from a host computer. Alternatively, or in addition, storage space may be allocated to a logical volume explicitly by a command from a host computer. Further, excess storage capacity may be de-allocated from logical volume explicitly by a command from a host computer.

The methods described herein may be embodied as logic instructions on a computer-readable medium. When executed on a processor such as, e.g., the processor 122 in host computer 110 or the processor 174 in storage controller 170, the logic instructions may cause the processor to be programmed as a special-purpose machine that implements the described methods. The processor, when configured by the logic instructions to execute the methods recited herein, constitutes structure for performing the described methods. The methods will be explained with reference to one or more logical volumes in a storage system, but the methods need not be limited to logical volumes. The methods are equally applicable to storage systems that map to physical storage, rather than logical storage.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A storage controller, comprising:
a first input/output port that provides an interface to a host computer;
a second input/output port that provides an interface to a storage device;
a processor that receives input/output requests generated by the host computer and, in response to the input/output requests, generates and transmits input/output requests to the storage device; and
a memory module communicatively connected to the processor and comprising logic instructions stored in a computer-readable medium which, when executed by the processor, configure the processor to:
receive, from the host computer, a write input/output request that identifies a logical volume;
compare an amount of storage space available in the logical volume with an amount of storage space required to complete the write operation; and
allocate additional storage space to the logical volume when the amount of storage space available in the logical volume is insufficient to complete the write operation.

2. The storage controller of claim 1, wherein the memory module further comprises logic instructions stored in a computer-readable medium which, when executed by the processor, configure the processor to update meta data associated with the logical volume to reflect an allocation of additional storage space to the logical volume.

3. The storage controller of claim 1, wherein the memory module further comprises logic instructions stored in a computer-readable medium which, when executed by the processor, configure the processor to dispatch the write operation to the logical volume

4. The storage controller of claim 1, wherein the memory module further comprises logic instructions stored in a computer-readable medium which, when executed by the processor, configure the processor to compare an amount of storage space allocated to the logical volume with sum of the amount of data currently stored in the logical and the amount of data specified in the write operation.

5. A storage controller, comprising:
a first input/output port that provides an interface to a host computer;
a second input/output port that provides an interface to a storage device;
a processor that receives input/output requests generated by the host computer and, in response to the input/output requests, generates and transmits input/output requests to the storage device; and
a memory module communicatively connected to the processor and comprising logic instructions stored in a computer-readable medium which, when executed by the processor, configure the processor to:
receive, from the host computer, a pre-allocate command that identifies a logical volume;
validate the pre-allocate command; and
allocate data from a free storage space to the logical volume identified in the pre-allocate command.

6. The storage controller of claim 5, wherein the memory module further comprises logic instructions stored in a computer-readable medium which, when executed by the processor, configure the processor to validate the identity of the logical volume identified in the pre-allocate command.

7. The storage controller of claim 5, wherein:
the pre-allocate command specifies an amount of memory to pre-allocate to the logical volume; and
the memory module further comprises logic instructions stored in a computer-readable medium which, when executed by the processor, configure the processor to verify that the free storage space includes sufficient space to allocate the amount of memory to the logical volume.

8. The storage controller of claim 5, wherein the memory module further comprises logic instructions stored in a computer-readable medium which, when executed by the processor, configure the processor to transmit a response to a host computer when a specific bit is set in the pre-allocate command.

9. The storage controller of claim 5, wherein the memory module further comprises logic instructions stored in a computer-readable medium which, when executed by the processor, configure the processor to update meta data associated with the logical volume to reflect an allocation of additional storage space to the logical volume.

10. The storage controller of claim 5, wherein the memory module further comprises logic instructions stored in a computer-readable medium which, when executed by the processor, configure the processor to transmit a response to a host computer when the space is allocated to the logical volume.

11. A storage controller, comprising:
a first input/output port that provides an interface to a host computer;
a second input/output port that provides an interface to a storage device;
a processor that receives input/output requests generated by the host computer and, in response to the input/output requests, generates and transmits input/output requests to the storage device; and
a memory module communicatively connected to the processor and comprising logic instructions stored in a computer-readable medium which, when executed by the processor, configure the processor to:
receive, from the host computer, a de-allocate command that identifies a logical volume;
validate the de-allocate command; and
de-allocate data from the logical volume identified in the de-allocate command.

12. The storage controller of claim 11, wherein the memory module further comprises logic instructions stored in a computer-readable medium which, when executed by the processor, configure the processor to validate the identity of the logical volume identified in the de-allocate command.

13. The storage controller of claim 11, wherein:
the de-allocate command specifies an amount of memory to de-allocate from the logical volume; and
the memory module further comprises logic instructions stored in a computer-readable medium which, when executed by the processor, configure the processor to verify that the logical volume includes sufficient space to de-allocate the amount from the logical volume.

14. The storage controller of claim 11, wherein the memory module further comprises logic instructions stored in a computer-readable medium which, when executed by the processor, configure the processor to transmit a response to a host computer when a specific bit is set in the de-allocate command.

15. The storage controller of claim 11, wherein the memory module further comprises logic instructions stored in a computer-readable medium which, when executed by the processor, configure the processor to update meta data associated with the logical volume to reflect a de-allocation of additional storage space to the logical volume.

16. The storage controller of claim 11, wherein the memory module further comprises logic instructions stored in a computer-readable medium which, when executed by the processor, configure the processor to transmit a response to a host computer when the space is de-allocated from the logical volume.
